(19) United States
(12) Patent Application Publication
(10) Pub. No.: US 2025/0062928 A1
(43) Pub. Date: Feb. 20, 2025

(54) APPARATUS AND METHOD FOR PROVIDING MEETING RECORDS IN ARTIFICIAL INTELLIGENCE-BASED CHAT ROOM

(71) Applicants: Jae Ho CHOI, Seoul (KR); Seo Hyun CHOI, Seoul (KR); Delta PDS CO., LTD., Seoul (KR)

(72) Inventors: Jae Ho CHOI, Seoul (KR); Seo Hyun CHOI, Seoul (KR)

(73) Assignees: Jae Ho CHOI, Seoul (KR); Seo Hyun CHOI, Seoul (KR); Delta PDS CO., LTD., Seoul (KR)

(21) Appl. No.: 18/800,696

(22) Filed: Aug. 12, 2024

(30) Foreign Application Priority Data
Aug. 18, 2023 (KR) 10-2023-0108514
Oct. 12, 2023 (KR) 10-2023-0135922
Jun. 7, 2024 (KR) 10-2024-0074511
Jul. 26, 2024 (KR) 10-2024-0099642

(51) Int. Cl. H04L 12/18

(52) U.S. Cl. CPC H04L 12/1831

(57) ABSTRACT

An apparatus for providing meeting records in an artificial intelligence-based chat room, includes a memory and a processor electrically connected to the memory. The processor is configured to: receive from a user terminal a user's selection for a chat room in which work participants are participating, receive a conversation recording file that records a conversation among the work participants related to meeting contents, generate meeting records obtained by converting the meeting contents into the text form by applying an artificial intelligence model to the conversation recording file according to the user's request for generating meeting records, and share the meeting records through a chat room related to the user's selection.

### CROSS-REFERENCE TO PRIOR APPLICATIONS

This Application claims priority to Korean Patent Application Nos. 10-2023-0108514 (filed on Aug. 18, 2023), 10-2023-0135922 (filed on Oct. 12, 2023), 10-2024-0074511 (filed on Jun. 7, 2024), and 10-2024-0099642 (filed on Jul. 26, 2024), which are all hereby incorporated by reference in their entirety.

### BACKGROUND

The present disclosure relates to a technology for providing meeting records and more specifically, to a technology that supports effective fulfillment of a project and work by facilitating communication among project participants throughout the project duration based on automated recording of meeting contents discussed among project participants and sharing of the meeting records through a chat room.

In general, an Internet messenger is typically an application that transmits text or graphic messages between users and may function as a chat room in which multiple users participate. In one embodiment, the Internet messenger may be a mobile messenger executed in a mobile environment (e.g., a mobile phone) and may include a mobile application, such as KakaoTalk, Line, WeChat, or Facebook messenger. In addition, these Internet messengers are increasingly being utilized in a variety of ways in the management and progress of work.

In particular, as the scale of a project gradually increases and the structure of the project becomes more complex, the number of chat rooms in which work participants participate simultaneously within a single project is also increasing. It may make it challenging for work participants to easily understand the flow of related work amidst a distributed communication process across multiple chat rooms.

Accordingly, a range of tools are being developed to support communication among various project participants. For example, meeting records that record the contents of meetings may be summarized, stored, and shared among users to easily facilitate sharing of project progress. Also, various tasks related to the contents of a meeting may be generated and shared among participants.

However, since generating meeting records and tasks require additional human resources and time, a technology for improving efficiency in the process of generating meeting records and tasks is needed.

Prior art reference: Korean registered patent No. 10-1182535 (Sep. 6, 2012)

### SUMMARY

An embodiment of the present disclosure provides an apparatus and a method for providing meeting records in an artificial intelligence-based chat room, which support effective fulfillment of a project and work by facilitating communication among project participants throughout the project duration based on automated recording of meeting contents discussed among project participants and sharing of the meeting records through a chat room.

Among embodiments, an apparatus for providing meeting records in an artificial intelligence-based chat room may comprise a memory; and a processor electrically connected to the memory, wherein the processor is configured to receive from a user terminal a user's selection for a chat room in which work participants are participating, receive a conversation recording file that records a conversation among the work participants related to meeting contents, generate meeting records obtained by converting the meeting contents into the text form by applying an artificial intelligence model to the conversation recording file according to the user's request for generating meeting records, and share the meeting records through a chat room related to the user's selection.

The processor may generate to-do recommendations related to the meeting contents through the artificial intelligence model when a to-do recommendation request related to the meeting records is received from the user terminal.

The processor may generate a to-do recommendation list that includes the to-do recommendations and selection options for each to-do recommendation and add the to-do recommendation list to the meeting records or provide the to-do recommendation list through the chat room.

If a specific work participant's selection is entered through the selection option for each to-do recommendation within the chat room, the processor may generate a task related to the corresponding to-do recommendation.

If a plurality of selection options are selected by the specific work participant, the processor may sequentially generate tasks for the individual to-do recommendations.

If the specific work participant has access rights to the meeting records, the processor may activate selection options for the to-do recommendation; otherwise, the processor may request approval from a work participant having the access rights to activate the selection options for the to-do recommendation.

The processor may insert the meeting records into the chat room or a meeting map for managing meeting records depending on the location of the meeting records generation request.

The processor may provide a list related to the meeting records in response to a request from any one of the work participants on the chat room or meeting map.

The processor may receive a conversation among the work participants through streaming from the respective user terminals in real-time and generate the conversation recording file.

The processor may input the conversation recording file into the artificial intelligence model to generate a script obtained by converting speeches of the work participants into text and a summary of the script and then generate the meeting records based on at least one of the script and the summary.

The processor may display the script or the summary as a conversation message of a chat room related to the user's selection.

When receiving a selection for the conversation message from any one of the work participants, the processor may display an interface related to the conversation message.

The processor may provide through the interface at least one of a plurality of functions including viewing a script related to the conversation message, viewing a summary, listening to a conversation recording file, and generating to-dos.

The processor may identify the conversational tone of each work participant in the process of recognizing speeches of the work participants and convert the script or the summary to a conversation message to which the conversational tone is applied in the process of displaying the script or the summary as the conversation message.

The processor may selectively provide a translation function in the process of providing the meeting records, the script, or the summary.

The processor may share the meeting records by using at least one of a plurality of methods including message display, file attachment, and link sharing within the chat room.

Among embodiments, in a method performed by an apparatus for providing meeting records comprising a memory and a processor electrically connected to the memory, a method for providing meeting records within an artificial intelligence-based chat room is performed by the processor and comprises receiving from a user terminal a user's selection for a chat room in which work participants are participating; receiving a conversation recording file that records a conversation among the work participants related to meeting contents; generating meeting records obtained by converting the meeting contents into the text form by applying an artificial intelligence model to the conversation recording file according to the user's request for generating meeting records; and sharing the meeting records through a chat room related to the user's selection.

The present disclosure may provide the following effects. However, since it is not meant that a specific embodiment has to provide all of or only the following effects, the technical scope of the present disclosure should not be regarded as being limited by the specific embodiment.

An apparatus and a method for providing meeting records in an artificial intelligence-based chat room according to one embodiment of the present disclosure may support effective fulfillment of a project and work by facilitating communication among project participants throughout the project duration based on automated recording of meeting contents discussed among project participants and sharing of the meeting records through a chat room.

### BRIEF DESCRIPTION OF THE DRAWINGS

FIG. 1 illustrates a system for providing meeting records according to the present disclosure.

FIG. 2 illustrates a system structure of the meeting records providing apparatus of FIG. 1.

FIG. 3 illustrates a functional structure of the processor of FIG. 2.

FIG. 4 is a flow diagram illustrating a method for providing meeting records in an artificial intelligence-based chat room according to the present disclosure.

FIG. 5 illustrates one embodiment of meeting records according to the present disclosure.

FIG. 6 illustrates one embodiment of a process for generating a conversation message according to the present disclosure.

FIG. 7 illustrates one embodiment of a process for providing related functions in a chat room according to the present disclosure.

FIG. 8 illustrates one embodiment of a task generation process according to the present disclosure.

FIG. 9 illustrates one embodiment of a process for modifying a task according to the present disclosure.

FIG. 10 illustrates general meeting records and to-do meeting records according to the present disclosure.

FIG. 11 illustrates one embodiment of a process for updating a to-do recommendation list according to the present disclosure.

FIGS. 12A and 12B illustrate various embodiments of a process for sharing meeting records in a chat room according to the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

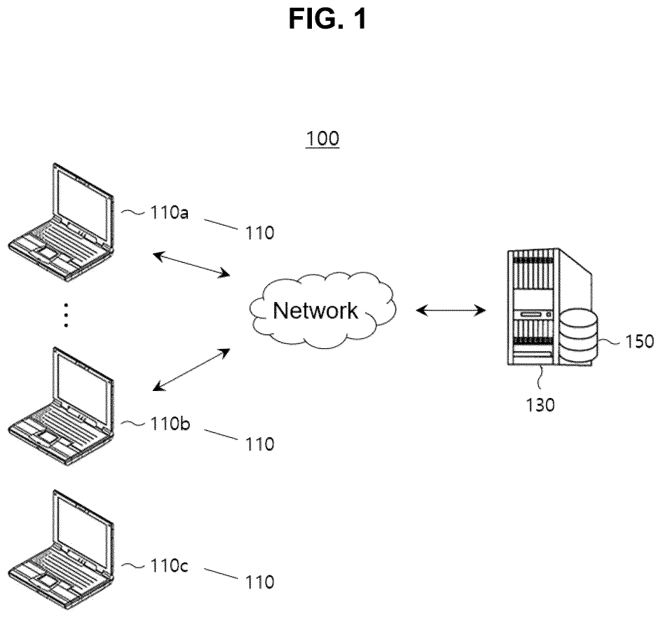

FIG. 1 illustrates a system for providing meeting records according to the present disclosure.

Referring to FIG. 1, the system 100 for providing meeting records may comprise a plurality of user terminals 110, a meeting records providing apparatus 130, and a database 150.

The user terminal 110 may correspond to a computing device operated by a user. For example, the user terminal 110 may be a desktop, laptop, tablet PC, or smartphone; however, it is not necessarily limited to the specific examples and may be implemented as various other devices.

The user terminal 110 may include one or more terminals; in this case, the user terminal 110 may include one or more than one of a first user terminal 110a, a second user terminal 110b, and a third user terminal 110c. For the sake of convenience, the user terminal 110 used by a first user may be referred to as the first user terminal 110a, the user terminal 110 used by a second user as the second user terminal 110b, and the user terminal 110 used by a third user is 110 as the third user terminal 110c.

In an embodiment of the present disclosure, a plurality of users may be included in one or more user groups. The user groups may be referred to as a first user group, a second user group, a third user group, and so on. Meanwhile, one user may belong to one or more user groups at the same time.

Also, a plurality of users may correspond to work participants involved in a common project or task. For example, work participants may include a task assigner who assigns the task, a task performer who performs the task, and a task-related individual related to the task.

At this time, a single overarching project may exist, including a plurality of work projects carried out independently. Also, plans, cards, notes, or tasks may be generated and stored in association with either the entire project or individual work projects.

Here, a plan may correspond to a work plan established to achieve a specific goal, a card may correspond to a management card for a series of tasks, and a note may correspond to a work record that stores work-related contents, and a task may correspond to a unit of work generated and processed according to a plan, card, or note.

Also, during the processing of plans, cards, notes, or tasks, objects such as messages, files, photos (or videos) may be shared among users, and a chat room may be provided for conversation and object sharing among the users. At this time, messages shared through the chat room may include everyday conversation messages and work messages related to work discussions.

In one embodiment, at least one of the user terminals 110 may be a mobile terminal and connected to the meeting records providing apparatus 130 through cellular communication or Wi-Fi communication. In another embodiment, at least one of the user terminals 110 may be a desktop and connected to the meeting records providing apparatus 130 via the Internet.

The meeting records providing apparatus 130 may correspond to a computing device that may be connected to at least one user terminal 110 through a network. In one embodiment, the meeting records providing apparatus 130 may manage at least one or more user groups, each of which includes a user and other associated users as members, namely, work participants.

In one embodiment, the meeting records providing apparatus 130 may be connected to the user terminal 110 through a dedicated agent installed on the user terminal 110. Here, the dedicated agent may correspond to an agent program, which is software that, when installed on the user terminal 110, enables interaction between the user terminal 110 and the meeting records providing apparatus 130 under the approval of the user terminal 110.

Meanwhile, the connection and interaction between the meeting records providing apparatus 130 and the user terminal 110 described herein may correspond to one embodiment and may be applied in various other forms within a typical range depending on various operational and implementation environments.

The database 150 may correspond to a storage device that stores various information required during the operation of the meeting records providing apparatus 130. For example, the database 150 may store conversation recording files capturing meeting discussions, voice files of users, or text information converted through speech recognition; however, the type of information stored is not necessarily limited to the examples above, and the database 150 may store information collected or processed in various forms during the process of performing the method for providing meeting records in an artificial intelligence-based chat room according to the present disclosure.

Also, in FIG. 1, the database 150 is shown as a logical storage device included in the meeting records providing apparatus 130; however, the database 150 is not necessarily limited to the specific implementation and may be implemented as a device separate from the meeting records providing apparatus 130.

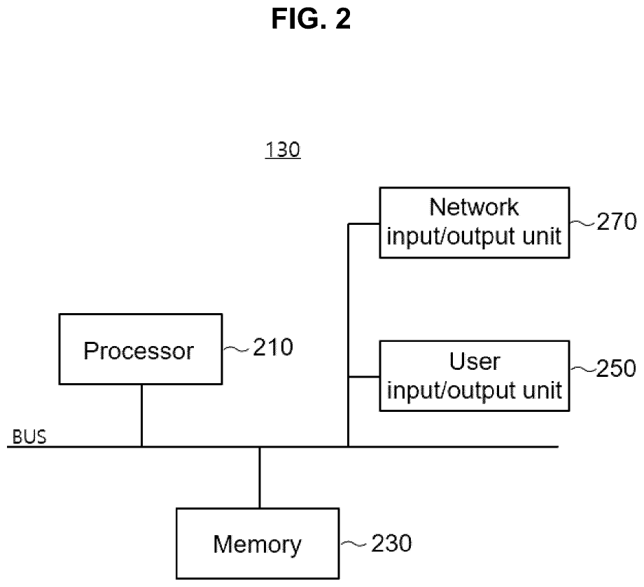

FIG. 2 illustrates a system structure of the meeting records providing apparatus of FIG. 1.

Referring to FIG. 2, the meeting records providing apparatus 130 may include a processor 210, a memory 230, a user input/output unit 250, and a network input/output unit 270.

The processor 210 may execute the artificial intelligence-based procedure for providing meeting records in a chat room according to the present disclosure, manage the memory 230 read or written during the execution, and schedule the synchronization between the volatile and non-volatile memory within the memory 230.

The processor 210 may control the overall operation of the meeting records providing apparatus 130; by being electrically connected to the memory 230, the user input/output unit 250, and the network input/output unit 270, the processor 210 may control the data flow among them. The processor 210 may be implemented as a Central Processing Unit (CPU) or a Graphics Processing Unit (GPU) of the meeting records providing apparatus 130.

The memory 230 may be implemented as non-volatile memory such as a solid-state disk (SSD) or a hard disk drive (HDD) and may include an auxiliary memory device used to store all data required for the meeting records providing apparatus 130 as well as main memory implemented as volatile memory, such as Random Access Memory (RAM). In this way, the memory 230 may be implemented as a combination of volatile and non-volatile memory; if implemented as non-volatile memory, the memory 230 may be connected through a hyperlink.

The user input/output unit 250 may include an environment for receiving user input and an environment for outputting specific information to the user, for example, an input device that includes or connects to an adaptor such as a mouse, trackball, touch pad, graphic tablet, scanner, touch screen, keyboard, or pointing device and an output device that includes an adaptor such as a monitor or a touchscreen. In one embodiment, the user input/output unit 250 may correspond to a computing device connected through a remote connection; in this case, the meeting records providing apparatus 130 may function as a server.

The network input/output unit 270 may provide a communication environment for connecting to the user terminal 110 through a network and may include adaptors for communication through, for example, Local Area Network (LAN), Metropolitan Area Network (MAN), Wide Area Network (WAN), and Value-Added Network (VAN). Also, the network input/output unit 270 may be implemented to provide wireless data transmission via Wi-Fi, short-range communication functions using Bluetooth, or wireless communication functions of 4G or higher.

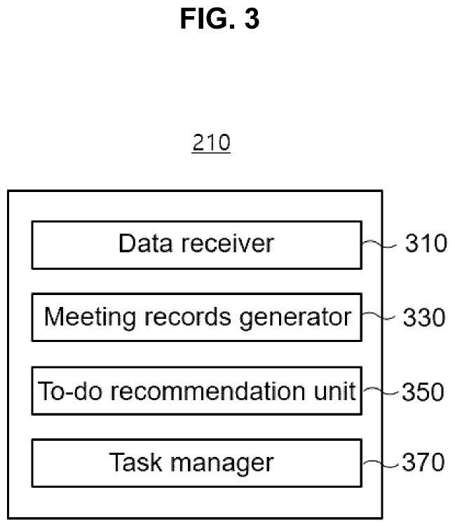

FIG. 3 illustrates a functional structure of the processor of FIG. 2.

Referring to FIG. 3, the meeting records providing apparatus 130 may perform the method for providing meeting records in an artificial intelligence-based chat room according to the present disclosure through the processor 210. To this end, the processor 210 may include a data receiver 310, a meeting records generator 330, a to-do recommendation unit 350, a task manager 370, and a controller (not shown in FIG. 3).

At this time, the embodiment of the present disclosure does not need to include all the functional components at the same time, and depending on embodiments, part of the components above may be omitted, or all or part of the components above may be selectively implemented. Also, one embodiment of the present disclosure may be implemented as an independent module that selectively includes part of the components above, and the artificial intelligence-based to-do recommendation method according to the present disclosure may be performed through interoperation among individual modules. In what follows, the operation of each component will be described in detail.

The data receiver 310 may receive a user's selection for chat rooms in which work participants are participating from the user terminal 110. Here, the user may check the list of chat rooms in which work participants are participating from the user terminal 110 and select a specific chat room within the list. Here, a chat room may correspond to a virtual conversation space for a user group to communicate in real-time. For example, a chat room may be implemented using a messenger program. A plurality of users may participate in the chat room at the same time, and participants may share text, speeches, images, videos, and files in real-time within the chat room. Also, a chat room may be organized around a specific topic; for the convenience of description, it is assumed that participants working on the same project join the chat room.

Also, the data receiver 310 may operate in conjunction with the user terminal 110 and receive the user's selection through a dedicated agent running on the user terminal 110. The user may check or retrieve the list of chat rooms in which work participants are participating and select a specific chat room on the user terminal 110. Accordingly, an input signal according to the user's selection behavior may be generated on the user terminal 110, and the input signal may be transmitted from the user terminal 110 to the data receiver 310. In this case, the input signal may include user identification information (e.g., user ID) and chat room identification information (e.g., chat room ID).

Also, the data receiver 310 may receive a conversation recording file that records a conversation related to the meeting contents among work participants. Here, the conversation recording file may correspond to a file that records conversations between work participants. At this time, a conversation among work participants may be recorded using a recording function included in the user terminal 110. In other words, the data receiver 310 may receive conversations from the user terminal 110 and then generate and store a conversation recording file or may directly receive a conversation recording file generated on the user terminal 110. Also, the data receiver 310 may provide an interface for inputting a conversation recording file through the user terminal 110, and the corresponding interface may be implemented through a dedicated agent operating on the user terminal 110.

In one embodiment, the data receiver 310 may receive a search key containing a keyword from the user terminal 110 and may determine one of the chat rooms identified based on the search key as having received the user's selection. In other words, the user may basically select a chat room within the chat rooms in which the user is participating; if necessary, the user may specify and select a chat room in various ways outside the chat room. Also, if the user participates in a plurality of chat rooms, the user may enter a keyword related to a chat room; the data receiver 310 may search for the chat room related to the corresponding user based on the keyword entered by the user. For example, the keyword may include the user's name or ID, or words related to work items. If only one chat room is found, the data receiver 310 may determine that the user's selection has been entered for the chat room; if multiple chat rooms are found, the data receiver 310 may determine that part of the plurality of chat rooms have been selected and the user's selection has been entered for the corresponding chat rooms.

In one embodiment, the data receiver 310 may receive a conversation among work participants through streaming from each user terminal 110 in real-time and generate a conversation recording file. The data receiver 310 may receive conversations among work participants in real-time through streaming in conjunction with each user terminal 110 participating in the conversation and generate conversation recording files according to a speech data format such as WAV and MP3. At this time, work participants participating in the conversation may use a conversation or recording function within the chat room to input their individual speeches while participating in the same chat room; if necessary, work participants may use an independent conversation channel outside the chat room (e.g., a video conference) to input a conversation in real-time. Also, the data receiver 310 may save storage space for conversation recording files by compressing speech data received in real-time and may determine a compression scheme based on network conditions.

In one embodiment, the data receiver 310 may receive the user's speech file recorded on the user terminal 110. At this time, the user's speech file may correspond to one of various types of conversation recording files. In other words, the user's speech file may correspond to a case where only one work participant's speech is recorded in the conversation recording file. Therefore, it should be understood that the conversation recording file described below may be equally applied to the user's speech file within the possible range. The data receiver 310 may receive a speech file transmitted from the user terminal 110 and store the received speech file in the database 150. The user may generate a speech file by directly recording his or her voice through the user terminal 110 equipped with a voice recording function, such as a smartphone, tablet, or PC; select one of various speech files stored in the user terminal 110; and transmit the corresponding speech file.

The meeting records generator 330 may generate meeting records by converting meeting contents into the text form as a result of applying an artificial intelligence model to the conversation recording file according to a meeting records generation request from the user. Here, the meeting records generation request may correspond to a user request related to the generation of meeting records. The user request may involve a command or information that the user requests the system to perform in relation to the meeting records and may be entered by the user (e.g., a work participant) on the user terminal 110. In other words, the user request may include generating, retrieving, deleting, or modifying meeting records. The meeting records generator 330 may receive and interpret a user request input from the user terminal 110 and then support execution of a series of operations related to various requests that include the generation of meeting records.

Also, meeting records may correspond to work records that document the meeting contents discussed during a meeting among work participants and may correspond to a type of note generated in conjunction with the overall project or a work project. Accordingly, the meeting records may be generated by including at least the meeting contents converted into the text form. At this time, the meeting records may be manually generated by work participants participating in the meeting or automatically generated by artificial intelligence based on a file recording the meeting contents; the generated meeting records may be stored and managed in the database 150. Also, the meeting records generator 330 may operate in conjunction with independent modules for generating meeting records. In other words, the meeting records generator 330 may call a meeting records generation module to initiate the operation of generating meeting records.

More specifically, after converting a conversation recording file into text and generating conversation text related to meeting contents, the meeting records generator 330 may generate meeting records that include a summary of the conversation text and selection options for the individual to-do recommendations. The meeting records generator 330 may recognize the speeches of work participants from conversation recording files using a Speech-To-Text (STT) algorithm or a speech recognition model and identify each work participant's conversation from the corresponding speech to generate text in the conversation form into conversation text. At this time, the conversation text may correspond to a text file (or a document) generated by converting a conversation recorded during a meeting among work participants into text, which may be generated through an external Speech-To-Text (STT) server depending on the needs.

Also, conversation text may be used as input data for a text summary model, and the text summary model may generate a summary that summarizes the conversation text as output. Here, the text summary model may correspond to a language model that receives text or a text file as input and generates a summary that summarizes the text or text file. Also, the text summary model may be designed to generate a summary of meeting contents while simultaneously generating to-do recommendations related to the meeting contents.

For example, a text summary model may be implemented using ChatGPT. ChatGPT is a large language model and may correspond to an interactive artificial intelligence chatbot. In particular, GPT stands for ‘Generative Pre-trained Transformer’ and may correspond to generative Al that generates sentences by pre-training on a massive amount of data through machine learning. In this case, the text summary model may selectively generate at least one of a summary and to-do recommendations by setting data types and structure of the input and output.

In one embodiment, the meeting records generator 330 may insert meeting records into a chat room or a meeting map for managing meeting records depending on the location of a meeting records generation request. Here, the meeting map may correspond to a dedicated management tool for managing meeting records. Also, if meeting records are generated and inserted into a chat room according to a meeting records generation request, a message regarding the generation of meeting records may be shared through the chat room, and work participants may directly select the message to access the meeting records or download the meeting records file. Also, when meeting records are generated and inserted into the meeting map according to a meeting records generation request, various functions such as retrieval, modification, and deletion of meeting records may be performed through a dedicated interface provided on the meeting map. Meanwhile, meeting records inserted into the meeting map or chat room may be stored and managed through a separate memory area related to the meeting map or chat room.

In one embodiment, the meeting records generator 330 may generate a meeting records list according to a request from one of the work participants in a chat room in which work participants are participating or on a meeting map for managing meeting records. The meeting records generator 330 may provide an interface through which a meeting records retrieval request may be entered for each location that enables retrieval of meeting records, and the corresponding interface may be implemented through an application running on the user terminal 110. For example, work participants may activate a meeting records retrieval function through a menu in the chat room and activate the meeting records retrieval function through a dedicated interface provided on the meeting map.

Also, when meeting records are retrieved in the chat room according to a meeting records retrieval request, a meeting records list generated as a result of the retrieval may be shared through the chat room, and work participants may directly select specific meeting records from the meeting records list to access the corresponding meeting records or download a meeting records file. In this case, the meeting records list may be displayed in the form of a message within the chat room and may be displayed independently on the meeting map through a separate interface. In the meeting records list provided in the form of a list, meeting records may be sorted and displayed according to their generation time, or the meeting records may be sorted according to various other criteria other than the generation time.

Also, when meeting records are retrieved on the meeting map according to a meeting records retrieval request, various functions such as confirmation, modification, and deletion of individual meeting records along with a meeting records list may be executed through a dedicated interface. Meanwhile, the meeting records list retrieved within the meeting map or chat room may be temporarily generated, shared, and then deleted; if necessary, the meeting records list may be selectively stored and managed through a separate memory area related to the meeting map or chat room.

In one embodiment, the meeting records generator 330 may generate separate retrieval results for each type of meeting records. For example, the meeting records generator 330 may respond to a meeting records retrieval request and generate retrieval results by distinguishing general meeting records from to-do meeting records; in this case, a meeting records list may be generated separately for the general and to-do meeting records. Here, the general meeting records may correspond to meeting records that record usual meeting contents, while the to-do meeting records may include one or more to-do recommendations along with the usual meeting contents.

In one embodiment, the meeting records generator 330 may input the conversation recording file into the artificial intelligence model to generate a script obtained by converting speeches of the work participants into text and a summary of the script and then generate the meeting records based on at least one of the script and the summary. In other words, the script may correspond to a result obtained by converting the contents of the conversation among work participants, stored in the conversation recording file, into text, and the summary may correspond to a brief overview that highlights the key points of the script.

Here, the artificial intelligence model may correspond to a model built to receive a conversation recording file as input and generate output in the text format. For example, the artificial intelligence model may be implemented by including a speech recognition model that recognizes the speeches in the conversation recording file and outputs a script in the text form; and a text summary model that summarizes the text of the script and generates a summary. In other words, the artificial intelligence model may be implemented in a structure in which the speech recognition model and the text summary model are connected to each other, and at least one of the script and the summary may be selectively output from the outputs of the models.

In one embodiment, the artificial intelligence model may be trained and built to receive a conversation recording file as input and generate at least one of a script and a summary as output. For example, the artificial intelligence model may be built as a first model that receives a conversation recording file as input and generates a script as output. The artificial intelligence model may be built as a second model that receives a conversation recording file as input and generates a summary as output. The artificial intelligence model may be built as a third model that receives a conversation recording file as input and generates a script and a summary as outputs, respectively. Also, the artificial intelligence model may be built to support various types of input and output.

In one embodiment, the meeting records generator 330 may share the meeting records through a chat room related to the user's selection. The meeting records may include information such as a meeting title, meeting date and time, a participant list, a summary of meeting topics, meeting contents, decisions made, and a to-do list. The meeting records generator 330 may provide part of the information included in the meeting records through a chat room and may selectively provide the information requested by the user. Also, the meeting records generator 330 may share the meeting records within the chat room through various methods and may transmit a notification message to the user if an error occurs during the sharing process.

In one embodiment, the meeting records generator 330 may share the meeting records using at least one of a plurality of methods including message display, file attachment, and link sharing within the chat room. For example, in the case of message display, the contents of the meeting records may be inserted and displayed in the chat room in the form of a text message. In the case of file attachment, the meeting records file may be shared in the form of an attachment in the chat room, and users participating in the chat room may download the attached file. In the case of link sharing, a link to a server (e.g., a cloud server) with access to the meeting records may be displayed and shared through the chat room, and users participating in the chat room may then access the meeting records through the link.

In one embodiment, the meeting records generator 330 may display a script or a summary as a conversation message in a chat room related to the user's selection. At this time, other users participating in the chat room may recognize the chat message as a message entered by the user. In other words, the initiator of the conversation message may be the user who requested the generation or sharing of meeting records. For example, when work participant A participating in the chat room requests the generation of meeting records, a script or summary text related to the generated meeting records may be displayed within the chat room as a conversation message of work participant A. The meeting records generator 330 may basically convert the text of a script or a summary into a conversation message and share the message in the chat room; if necessary, the meeting records generator 330 may also display images or videos related to the contents of the script or the summary along with the conversation message.

In one embodiment, the meeting records generator 330 may display an interface related to a conversation message when receiving a selection for the conversation message from one of the work participants. In other words, each user participating in the chat room may directly select a shared chat message; when each user's selection is detected for a chat message, the meeting records generator 330 may provide functions related to the chat message through a separate interface. In this case, the corresponding interface may include basic functions such as copying, deleting, and sharing messages.

In one embodiment, the meeting records generator 330 may provide through the interface at least one of a plurality of functions including viewing a script related to a conversation message, viewing a summary, listening to a conversation recording file, and generating to-dos. In other words, when the conversation message corresponds to a script or a summary generated from a conversation recording file, the meeting records generator 330 may additionally provide functions related to the script or the summary through the interface. The script view function may correspond to a function that provides details of the script related to the corresponding summary, and the summary view function may correspond to a function that provides details of the summary related to the corresponding script. Also, the function of listening to a conversation recording file may correspond to the function of playing the conversation recording file related to the script or the summary, and the to-do generation function may correspond to the function of generating one or more to-do recommendations (or tasks) related to the script or the summary. The user may select a specific function through the interface and execute the operation for the selected function.

In one embodiment, the meeting records generator 330 may identify the conversational tone of each work participant in the process of recognizing the speeches of the work participants and convert the recognized speech into conversation messages, applying the identified conversational tone while displaying a script or a summary as conversation messages. Here, the conversational tone may reflect the linguistic characteristics of each user revealed during a voice conversation and may indicate the speaker's emotions, intentions, and relationships. The conversational tone may be determined by the features such as words and expressions used (e.g., informal speech, polite language, and so on), sentence structure and rules, pronunciation, speech rate, and intonation. The meeting records generator 330 may extract feature information such as vocabulary, grammar, and voice from the text while converting the speech signal into text during speech recognition of the conversation recording file and identify the users participating in the conversation and their conversational tones based on the extracted feature information. The process of identifying conversational tone may involve classifying various feature information and determining users and their conversational tone that match the classification results.

Also, the meeting records generator 330 may convert a script or a summary into conversation messages expressed in one of the conversational tones identified in the process of displaying the script or the summary as conversation messages in the chat room. For example, if one of the conversational tones identified from the conversation is a ‘friendly and comfortable tone,’ the meeting records generator 330 may convert the script or the summary according to the corresponding conversational tone to generate conversation messages that mimic the casual, friendly tone used in a conversations with friends. In this case, the meeting records generator 330 may perform a conversation message conversion operation using a tone conversion model trained to receive at least one of the script and the summary along with a conversational tone as input and generate conversation messages expressed in the corresponding conversational tone as output.

Meanwhile, the meeting records generator 330 may perform an operation of regenerating existing scripts and summaries by selectively applying a specific conversational tone; if the tone of the script differs from that of the summary, the meeting records generator 330 may compare the corresponding conversational tones as needed and convert the script and the summary to a specific conversational tone, either automatically or through selection, to ensure that both the script and the summary match the specific conversational tone.

In one embodiment, the meeting records generator 330 may generate and provide a plurality of conversation messages with various conversational tones during the process of displaying a script or a summary as conversation messages and display conversation messages selected by the user among the plurality of conversation messages through the chat room. The meeting records generator 330 may generate a plurality of conversation messages, each with a different conversational tone, using the tone conversion model. The meeting records generator 330 may provide a plurality of conversation messages to the user through a separate interface on the user terminal 110; the user may select a specific conversation message to be displayed in the chat room.

In one embodiment, the meeting records generator 330 may update at least one of conversation messages displayed in the chat room to employ a conversational tone set by the corresponding user and display the updated conversation message. The user may select an existing conversation message displayed in the chat room and apply a specific conversational tone to the selected message; if the conversational tone is changed by the user, the meeting records generator 330 may convert the corresponding conversation message to employ the changed conversational tone, update the existing conversation messages, and display the updated messages. At this time, the user may apply the specific conversational tone to one or more conversation messages so that the corresponding conversation messages are updated and displayed at the same time. Also, the user may select only those conversation messages entered during a specific time period among conversation messages displayed in the chat room and apply the specific conversational tone to the selected conversation messages.

In one embodiment, the meeting records generator 330 may selectively provide a translation function in the process of providing meeting records, scripts, or summaries. The meeting records generator 330 may provide detailed information through a detail page for the meeting records, script, or summary and may provide a separate, independent interface for the detail page. In other words, the meeting records generator 330 may provide a message translation function as one of various functions within the independent interface provided through the chat room. To this end, the corresponding interface may be implemented to operate in conjunction with a translation engine. By selecting the message translation function, users may receive translations of meeting records, scripts, or summaries within the chat room. Also, the meeting records generator 330 may provide each message displayed in the chat room along with its translated content through the interface and may replace a specific message with its translation and display the translated message.

When the to-do recommendation unit 350 receives a to-do recommendation request related to the meeting records from the user terminal 110, the to-do recommendation unit 350 may generate to-do recommendations related to the meeting contents through an artificial intelligence model. Here, the to-do recommendation request may correspond to a user request for one or more to-do recommendations related to the meeting contents. In this case, the artificial intelligence model for to-do recommendation may correspond to the artificial intelligence model used for the process of generating meeting records from a conversation recording file. In other words, while outputting meeting contents in the text form during the process of generating meeting records, the artificial intelligence model may also output to-do recommendations related to the meeting contents.

Also, the to-do recommendation unit 350 may generate to-do recommendations through a separate to-do recommendation model. Here, the to-do recommendation model may be implemented as a deep learning model that receives text related to the meeting contents as input and generates to-do recommendations as output; however, the to-do recommendation model is not necessarily limited to the specific example. Also, the to-do recommendation model may be built in conjunction with a to-do table that stores to-do recommendations, and in this case, the to-do recommendation model may generate index information of the table as to-do recommendation information. In other words, the to-do recommendation unit 350 may generate to-do recommendations by retrieving the to-do table based on the index information output by the to-do recommendation model.

In one embodiment, the to-do recommendation unit 350 may generate a to-do recommendation list that includes to-do recommendations and selection options for each to-do recommendation and add the to-do recommendation list to the meeting records or provide the to-do recommendation list to the user terminal 110. Here, the selection option may correspond to a function activated according to the user's selection for each of one or more to-do recommendations. For example, selection options may be implemented as checkboxes. In other words, the to-do recommendation list may correspond to a list of to-do recommendations and may be expressed as a set of pairs, each of which consists of a to-do recommendation and a selection option. In other words, users may individually select to-do recommendations through each selection option from the to-do recommendation list. The to-do recommendation unit 350 may generate a to-do recommendation list in response to a to-do recommendation request and provide the to-do recommendation list to the user terminal 110; the to-do recommendation list may be displayed through a dedicated interface implemented on the user terminal 110 or through the chat room.

In one embodiment, the to-do recommendation unit 350 may activate the selection option for each to-do recommendation if a specific work participant has access rights to meeting records; otherwise, the to-do recommendation unit 350 may request approval from a work participant with access rights to activate the selection option for each to-do recommendation. Basically, access to the meeting records may be granted to work participants participating in the meeting; when a to-do recommendation request is received, the to-do recommendation unit 350 may activate the selection option of the to-do recommendation only for those work participants with relevant access rights based on the retrieval results for the rights of the corresponding work participants.

If a work participant without access rights requests a to-do recommendation, the to-do recommendation unit 350 may provide a list of to-do recommendations with selection options for the to-do recommendations being disabled. Also, the to-do recommendation unit 350 may request approval for activation of the selection options from a work participant with access rights to the meeting records and may provide a to-do recommendation list with the selection options activated according to the approval of the corresponding work participant.

In one embodiment, the to-do recommendation unit 350 may convert specific meeting records into to-do meeting records by adding a to-do recommendation list to the specific meeting records corresponding to general meeting records. Here, general meeting records may correspond to meeting records that do not include to-do recommendations, and to-do meeting records may correspond to meeting records that include to-do recommendations. In other words, meeting records may be generated as general meeting records by default, and when to-do recommendations are generated in response to a work participant's request for to-do recommendations, the to-do recommendations may be generated and managed as separate objects independently from the meeting records. At this time, the to-do recommendation unit 350 may add the generated to-do recommendation list to the meeting records if needed, and as a result of adding the to-do recommendation list to the meeting records, general meeting records may be converted into to-do meeting records. The to-do recommendation unit 350 may perform the operation of converting general meeting records into to-do meeting records when a work participant's request is received or predetermined conditions are met.

In one embodiment, the to-do recommendation unit 350 may remove a specific to-do recommendation from the to-do recommendation list when a task is generated for the specific to-do recommendation included in the to-do meeting records. For example, if meeting records A contain to-do recommendations a and b, and a work participant generates a task for the to-do recommendation b, to-do recommendation b may be removed from meeting records A. Afterwards, when meeting records A are retrieved, only to-do recommendation a may be retrieved along with meeting records A. Meanwhile, the to-do recommendation unit 350 may maintain the corresponding to-do recommendation even when a task related to the to-do meeting records is generated. In other words, in the example above, even if a task is generated for to-do recommendation b, meeting records A may still include to-do recommendations a and b; when meeting records A are retrieved, to-do recommendations a and b may also be retrieved.

In one embodiment, the to-do recommendation unit 350 may convert the to-do meeting records into general meeting records when all to-do recommendations are removed from the to-do recommendation list. For example, when meeting records A include to-do recommendations a and b, and a work participant generates a task for to-do recommendation b, to-do recommendation b may be removed from meeting records A. Afterwards, when the work participant generates a task for to-do recommendation a, to-do recommendation a may be removed from meeting records A; if all to-do recommendations included in the to-do recommendation list are removed, to-do meeting records may be converted to general meeting records.

When a specific work participant's selection is entered through a selection option for each to-do recommendation within the chat room, the task manager 370 may generate a task related to the corresponding to-do recommendation. The work participant participating in the chat room may request generation of a task related to the to-do recommendation by selecting an activated selection option from the to-do recommendation list provided through the interface. The task manager 370 may initiate a task generation operation related to the to-do recommendation selected by the work participant through the selection option.

In one embodiment, the task manager 370 may designate the specific work participant as a task assigner of the corresponding task and set the corresponding to-do recommendations as the task contents. Tasks may be generated by including various work-related items. For example, a task may be generated by including a task assigner that generates the task, task contents, and the like. The task manager 370 may automatically set the work participant who requests task generation as the task assigner and automatically set the to-do recommendation as task contents.

In one embodiment, when the specific work participant selects a plurality of selection options, the task manager 370 may sequentially generate a task related to each of the to-do recommendations. If meeting records contain a plurality of to-do recommendations, the task generator may generate a task for each to-do recommendation by selecting a selection option for each to-do recommendation. In this case, the corresponding tasks may be generated sequentially according to the order in which the task generator selects the selection options. Also, the task manager 370 may generate a task by receiving task contents directly from the task generator in addition to the to-do recommendations; accordingly, a plurality of tasks related to meeting records may be sequentially generated.

In one embodiment, when the meeting records are generated within the chat room, the task manager 370 may insert the task into the chat room, insert the task into a task tab related to the chat room, or insert the task into a task tab related to the meeting records. The task manager 370 may generate and insert tasks at various locations; in particular, the location of generation and insertion of the task may be determined depending on the generation location of the meeting records. For example, if meeting records are generated in the chat room, and a task related to the to-do recommendation of the corresponding meeting records is created, the task may be inserted into the same chat room. When a task is inserted into the chat room, a notification of task generation and insertion may be provided through a chat room message.

In another example, a task generated within the chat room may be inserted into a task tab related to the corresponding chat room. Here, the task tab may correspond to a dedicated management tool for independently managing tasks; when the task tab is connected to a specific chat room, the task tab may be used to independently manage only the tasks generated within the corresponding chat room. In yet another example, a task generated for a to-do recommendation of specific meeting records may be inserted into the task tab related to the specific meeting records. If the task tab is connected to specific meeting records, the task tab may be used to independently manage only those tasks generated in connection with the specific meeting records. Therefore, depending on the location where a task is inserted after being generated, the task may be retrieved from the corresponding location, namely, the chat room, the task tab related to the chat room, or the task tab related to meeting records.

In one embodiment, when the meeting records are generated within the meeting map, the task manager 370 may insert the task into a task tab related to the meeting map, insert the task into a task tab related to the meeting records, or generate a chat room related to the meeting records and insert the task into the chat room. The task manager 370 may generate and insert a task within the meeting map, and the location of generation and insertion of the task may be determined accordingly. For example, a task for which meeting records are generated within a meeting map may be inserted into the task tab related to the corresponding meeting map. If the task tab is connected to a specific meeting map, only the tasks generated within the corresponding meeting map may be managed independently.

In another example, a task generated for a to-do recommendation of specific meeting records may be inserted into the task tab related to the specific meeting records; in the absence of a chat room related to the specific meeting records, a chat room may be generated, and the task may be directly inserted to the corresponding chat room. When a task is inserted into the chat room, a notification of task generation and insertion may be provided through a chat room message. In this case, a work participant may select the corresponding chat room message and move to the meeting map where the task was generated or access the specific meeting records.

The controller (not shown in FIG. 3) may control the overall operation of the meeting records providing apparatus 130 and manage control flow or data flow through the data receiver 310, meeting records generator 330, to-do recommendation unit 350, and the task manager 370.

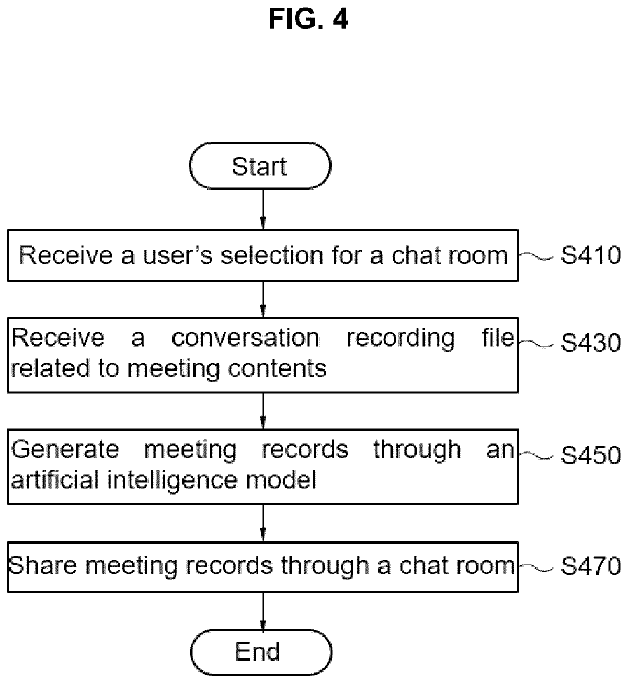

FIG. 4 is a flow diagram illustrating a method for providing meeting records in an artificial intelligence-based chat room according to the present disclosure.

Referring to FIG. 4, the meeting records providing apparatus 130 may receive from the user terminal 110 the user's selection of a chat room in which work participants are participating through the processor 210 S410. The meeting records providing apparatus 130 may receive a conversation recording file that records a conversation among work participants regarding meeting contents through the processor 210 S430.

Also, the meeting records providing apparatus 130 may generate meeting records in which the meeting contents have been converted into the text form as a result of applying an artificial intelligence model to the conversation recording file according to the user's request for meeting records generation through the processor 210 S450. The meeting records providing apparatus 130 may share the meeting records via the chat room related to the user's selection through the processor 210 S470.

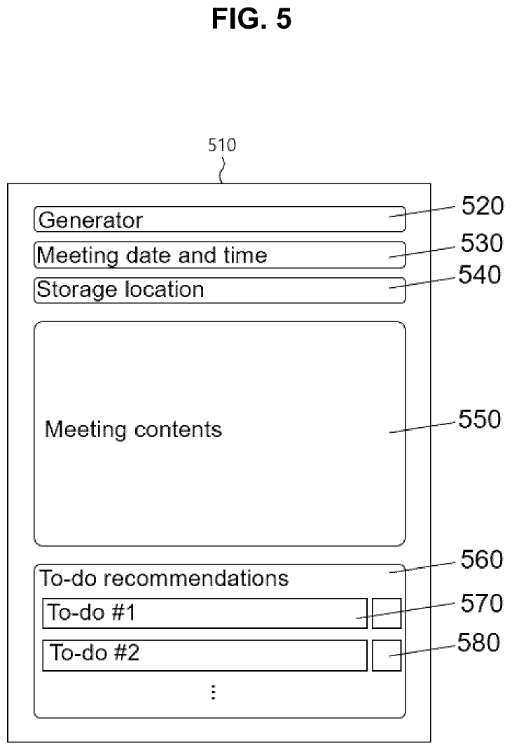

FIG. 5 illustrates one embodiment of meeting records according to the present disclosure.

Referring to FIG. 5, the meeting records providing apparatus 130 may retrieve and provide meeting records that record meeting contents 550 among work participants in response to a meeting records retrieval request. At this time, the meeting records 510 may be generated manually by work participants or automatically by an artificial intelligence model.

In one embodiment, as shown in FIG. 5, the meeting records 510 may be generated by including meeting contents 550 automatically summarized by the artificial intelligence model and to-do recommendations 560 recommended by the artificial intelligence model and may include various items. For example, the meeting records 510 may include a generator 520, meeting date and time 530, storage location 540, meeting contents 550, and to-do recommendations 560.

The generator 520 may correspond to a user who has generated the meeting records, which may correspond to one of the work participants involved in the meeting. Generator information may be automatically determined based on a meeting records generation request. The meeting date and time 530 represents when the meeting was held and may include the date, day, and time; the meeting date and time may be automatically determined based on the time of the meeting records generation request.

Also, the storage location 540 may correspond to a location where the meeting records 510 are generated and stored. For example, the storage location 540 may correspond to the information on the space (e.g., folder name) in which actual meeting records are stored within the user terminal 110 or meeting records providing apparatus 130; in some cases, the storage location 540 may be expressed as the information on a link that provides access to the meeting records 510.

Also, the meeting contents 550 may correspond to a summary of the meeting contents, automatically summarized by the artificial intelligence model and may correspond to text information generated through speech recognition from a conversation recording file that captures the meeting contents. The to-do recommendations 560 may correspond to to-do information automatically recommended by the artificial intelligence model and may include work information related to the meeting contents. The to-do recommendations 560 may be generated by including one or more specific to-dos 570 and selection options 580. The specific to-do 570 may briefly express the title or purpose of a to-do in the text form. The selection option 580 may be generated independently for each specific to-do 570 and may be implemented in various ways, using checkboxes or radio buttons.

Also, the meeting records 510 may include the meeting name or meeting participant information and may include various meeting records menus. For example, the meeting records menu may include a task generation reservation menu, a shared link generation menu, and an upload menu for files, images, and videos. At this time, the meeting records menus may be provided together with the meeting records when the meeting records are retrieved after generation of the meeting records.

The task generation reservation menu may correspond to a function that schedules task generation based on a specific point in time by a work participant with access rights after generation of the meeting records. In other words, if task generation is scheduled at time point A, a notification or a reminder for task generation may be provided to the work participants who have made the reservation at time point A. The shared link generation menu may correspond to a function that enables generation of a shared link providing direct access to the meeting records from outside. The upload menu may correspond to a function that enables adding files or images related to the meeting contents to the meeting records after generation of the meeting records.

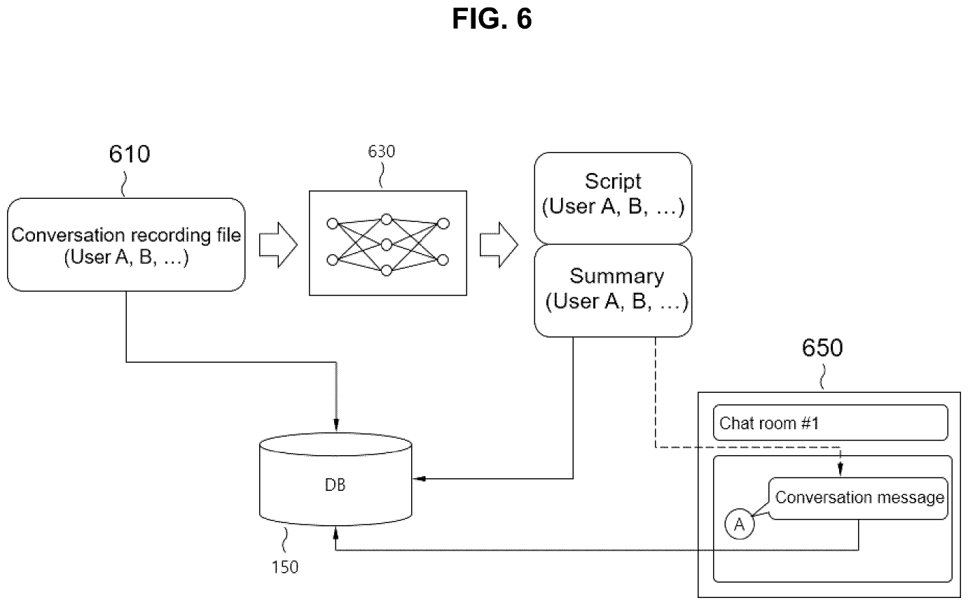

FIG. 6 illustrates one embodiment of a process for generating a conversation message according to the present disclosure.

Referring to FIG. 6, the meeting records providing apparatus 130 may generate a script and a summary of the meeting contents by inputting the conversation recording file 610 into the artificial intelligence model 630 in response to the user's request for generating meeting records; also, the meeting records providing apparatus 130 may share the script or the summary through a chat room 650 related to the user's selection.

For this purpose, the meeting records providing apparatus 130 may receive a conversation recording file 610 related to the conversation among users A and B and others recorded on the user terminal 110. The meeting records providing apparatus 130 may recognize the speeches in the conversation recording file 610 and generate a script and a summary converted into text, respectively. At this time, the summary may be generated based on the script. In other words, the artificial intelligence model 630 may be designed to receive a conversation recording file as input and output a text-type script and summary related to the meeting contents. Afterwards, the meeting records providing apparatus 130 may display the text contents of the script or summary as conversation messages within the chat room 650 related to the user's selection.

Also, the meeting records providing apparatus 130 may store and manage scripts, summaries, and conversation messages related to the conversation recording file 610 that records the conversation among users A and B and others in the database 150. When a conversation message is selected within the chat room 650, the meeting records providing apparatus 130 may search the database 150 and provide the corresponding conversation recording file, script, summary, and other information related to the conversation message.

To this end, while displaying the conversation message through the chat room 650, the meeting records providing apparatus 130 may provide a detailed view page for the conversation message. In other words, the meeting records providing apparatus 130 may provide a detailed view menu along with a conversation message. The user may access the detailed view page that provides details of the conversation message by selecting (e.g., clicking) the detail view menu of the conversation message. For example, the detailed view page of a conversation message may provide at least one of a conversation recording file, script, and summary related to the conversation message. At this time, access to the conversation recording file, script, or summary provided through the detailed view page may be restricted to other users depending on the privacy settings set by the user who generated the conversation message.

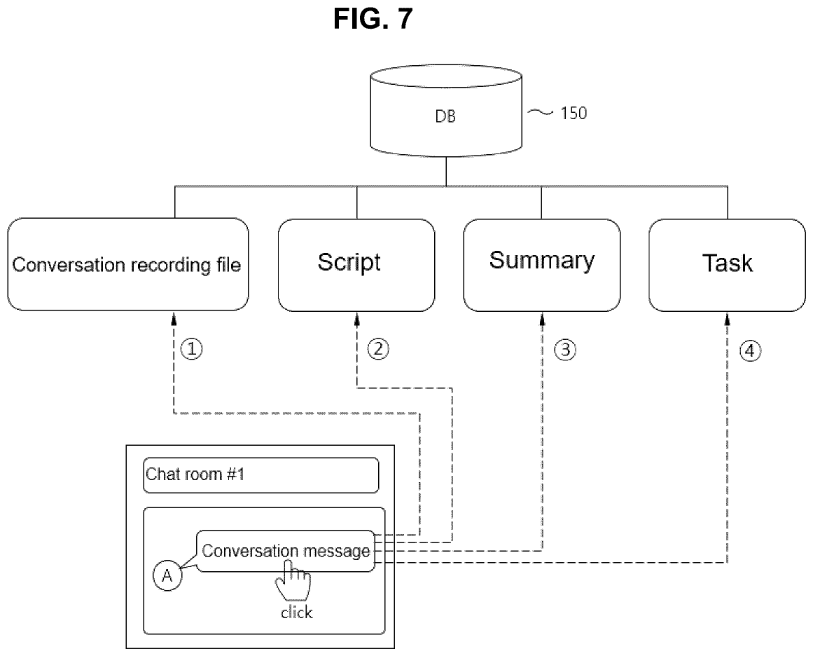

FIG. 7 illustrates one embodiment of a process for providing related functions in a chat room according to the present disclosure.

Referring to FIG. 7, when the meeting records providing apparatus 130 receives a selection of a conversation message from a participant of the chat room, the meeting records providing apparatus 130 may display an interface related to the conversation message. In this case, the interface may include functions related to the conversation message. For example, the interface may provide functions such as (1) listening to a conversation recording file, (2) viewing a script, 3) viewing a message, and 4) generating a task; and the user may select a specific function to access the corresponding contents. The meeting records providing apparatus 130 may access the database 150, search for data related to the user's selection, and provide the information related to the user's selection through the user terminal 110.

Also, the meeting records providing apparatus 130 may restrict provision of the interface even for users participating in the chat room if they do not have rights to access the corresponding conversation message (or meeting records). In other words, when a conversation message is selected by a user without access rights, the meeting records providing apparatus 130 may not perform the operation for providing an interface according to the user's message selection. To this end, when the meeting records providing apparatus 130 displays a conversation message related to a script or a summary through the chat room, the meeting records providing apparatus 130 may configure access rights for the corresponding conversation message.

In other words, when the meeting records providing apparatus 130 displays a script or a summary extracted from the conversation recording file capturing a conversation among work participants as a conversation message in the chat room, the meeting records providing apparatus 130 may allow access rights preconfigured by the user. For example, when meeting contents discussed among a plurality of work participants are shared as a conversation message through the chat room, access to the conversation message may be configured to be restricted for other users in the chat room, who do not participate in the meeting. In other words, the meeting records providing apparatus 130 may restrict the access rights for other users while displaying the corresponding conversation message in the chat room.

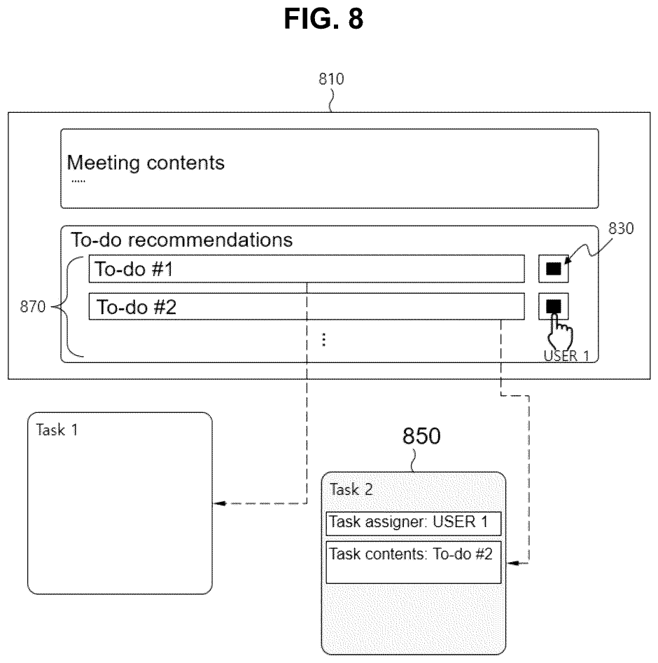

FIG. 8 illustrates one embodiment of a task generation process according to the present disclosure.

Referring to FIG. 8, the meeting records providing apparatus 130 may retrieve meeting records based on their classification as either general meeting records or to-do meeting records 810 according to whether or not to-do recommendations are included and then generate a retrieval result. Unlike general meeting records, the to-do meeting records 810 may include a to-do recommendation list 870 related to the meeting contents within the meeting records. In other words, work participants may check detailed items by selecting specific meeting records from a meeting records list provided as a result of retrieving meeting records and may generate related tasks by selecting part of the to-do recommendations included in the meeting records. Here, a task may correspond to the minimum unit of work related to a project.

Specifically, detailed items of the meeting records provided to work participants may include a summary of the meeting contents and to-do recommendations related to the meeting contents, and selection options 830, which may be selected individually, may be included for each to-do recommendation. At this time, the meeting records providing apparatus 130 may change the activation state of each to-do recommendation based on the work participant and provide the to-do recommendation with the changed activation state. For example, the meeting records providing apparatus 130 may activate the selection option 830 and provide the activated selection option 830 when a work participant has normal access rights or has high priority for the corresponding to-do recommendation. In other words, the activation state of the selection option 830 may correspond to a state in which a to-do recommendation may be selected by a work participant.

As shown in FIG. 8, when to-do #1 and to-do #2 are selected separately by a work participant (USER 1), the corresponding selection options 830 may be converted to a ‘selected’ state, and the meeting records providing apparatus 130 may generate tasks (Task 1 and Task 2) that match the corresponding to-dos. At this time, Task 2 may correspond to the task 850 generated in response to to-do #2 among the to-do recommendations. The corresponding task 850 may correspond to a task in a temporary state with some items left empty.

In this case, when the corresponding task 850 is generated, the task assigner may be automatically set to ‘USER 1’ who has requested generation of the corresponding task, and the task contents may be automatically configured based on the contents of ‘to-do #2’ selected by USER 1. Also, the corresponding task 850 may be generated and stored with information on the remaining items left empty, excluding the task assigner and task contents; the corresponding items may be entered later by the work participant (USER 1).

Meanwhile, the corresponding task 850 may be generated and stored with all items entered through additional input from the work participant, and some items may be generated but stored with empty contents according to the work participant's selective input.

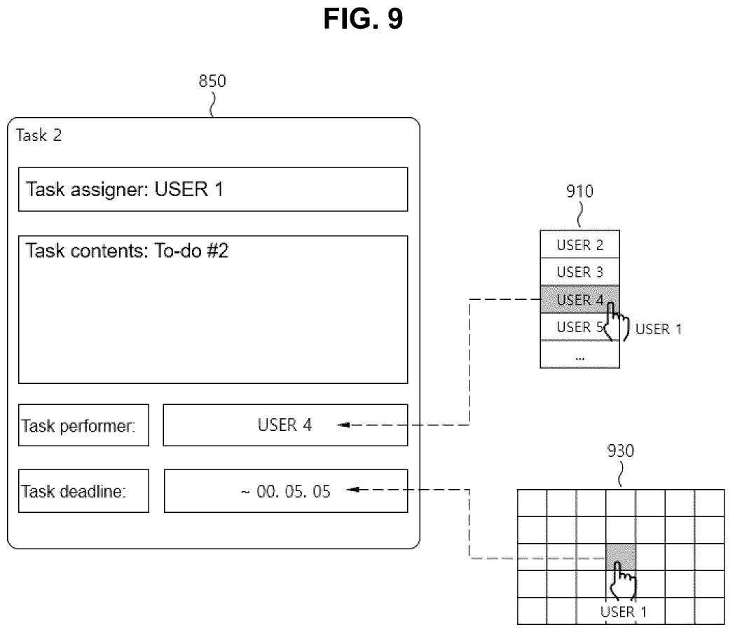

FIG. 9 illustrates one embodiment of a process for modifying a task according to the present disclosure.

Referring to FIG. 9, the meeting records providing apparatus 130 may generate a task 850 according to the work participant's selection for each to-do recommendation included in the meeting records. At this time, the meeting records providing apparatus 130 may allow task modification rights to the work participant who generated the task 850.

In the case of FIG. 9, the task 850 may be generated with the work participant ‘USER 1,’ who requested task generation for recommended ‘to-do #2’ of FIG. 8, set as a task assigner and the contents of the selected ‘to-do #2’ set as the task contents.

Afterwards, the meeting records providing apparatus 130 may update the corresponding task 850 by receiving input for the empty items from the work participant ‘USER 1’ with task modification rights through the input interfaces 910, 930.

For example, the task performer may be set as another work participant ‘USER 4’ selected by work participant ‘USER 1’ on the first input interface 910, and the task deadline may be set to ‘00.05.05’ as entered by work participant ‘USER 1’ on the second input interface 930. In other words, the meeting records providing apparatus 130 may update the corresponding task 850 when the remaining information is input by a work participant.

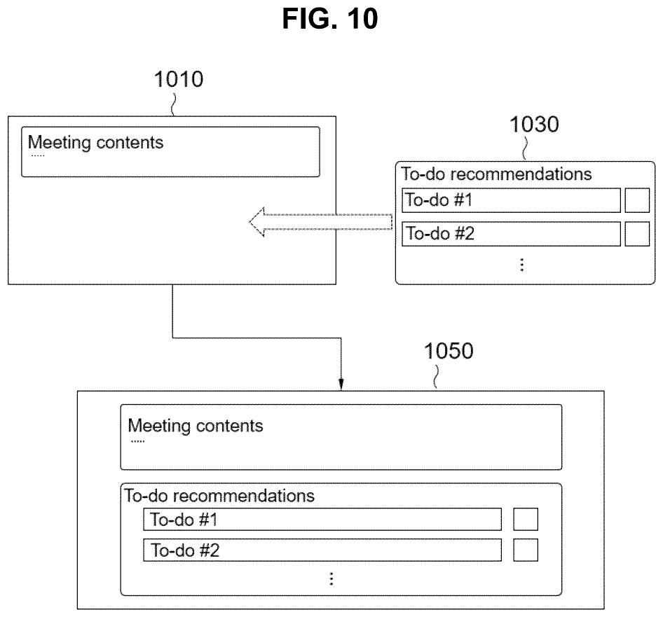

FIG. 10 illustrates general meeting records and to-do meeting records according to the present disclosure.

Referring to FIG. 10, the meeting records providing apparatus 130 may add a to-do recommendation list 1030 to general meeting records to convert the general meeting records 1010 into to-do meeting records 1050. The general meeting records 1010 may correspond to meeting records that do not include to-do recommendations, while the to-do meeting records 1050 may correspond to meeting records that include to-do recommendations. In other words, the meeting records providing apparatus 130 may initially generate and store general meeting records 1010 that do not include to-do recommendations. The meeting records providing apparatus 130 may convert general meeting records 1010 into to-do meeting records 1050 by adding the to-do recommendation list 1030 to the general meeting records 1010 when a work participant requests conversion or specific conditions are met. In this case, the work participant may also check to-do recommendations related to the meeting records through a retrieval result for the meeting records and may easily generate tasks related to the to-do recommendations by selecting the to-do recommendations as needed.

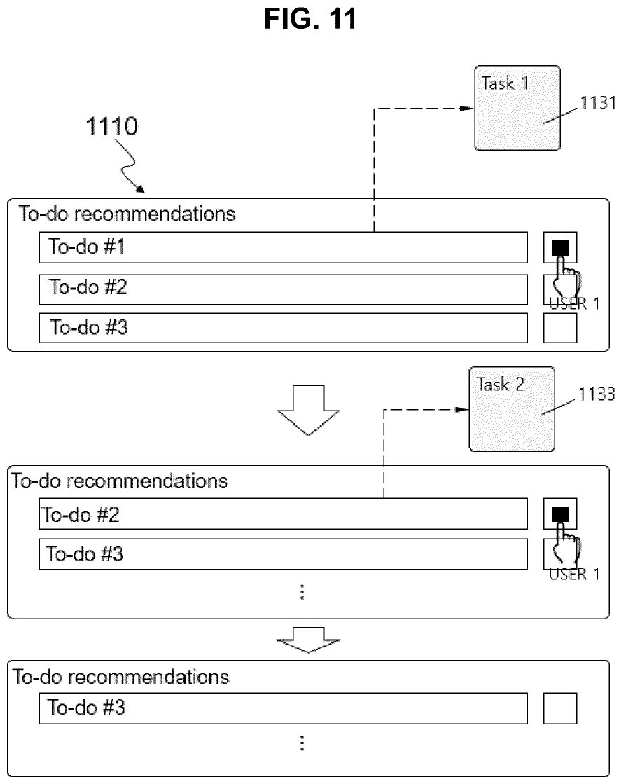

FIG. 11 illustrates one embodiment of a process for updating a to-do recommendation list according to the present disclosure.

Referring to FIG. 11, the meeting records providing apparatus 130 may remove a specific to-do recommendation from the to-do recommendation list 1110 when a task is generated by a work participant selecting the specific to-do recommendation on the to-do recommendation list 1110 included in the to-do meeting records. For example, as shown in FIG. 11, when the to-do recommendation list 1110 includes to-do #1, to-do #2, and to-do #3, work participant ‘USER 1’ may select the selection option for to-do #1 to generate a first task 1131 for to-do #1. The meeting records providing apparatus 130 may remove to-do #1 from the to-do recommendation list 1110 when generation of the first task 1131 for to-do #1 is completed.

Also, work participant ‘USER 1’ may select the selection option for to-do #2 and generate a second task 1133 for to-do #2. The meeting records providing apparatus 130 may remove to-do #2 from the to-do recommendation list 1110 when generation of the second task 1133 for to-do #2 is completed. If all to-do recommendations are removed from the to-do recommendation list 1110 due to sequential task generation for the remaining to-do recommendations that include to-do #3, the meeting records providing apparatus 130 may convert the to-do meeting records into general meeting records.

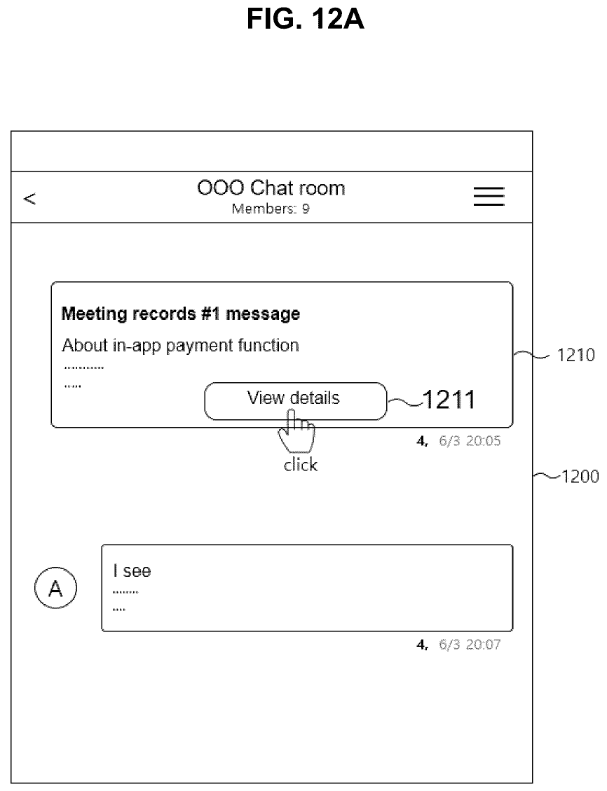

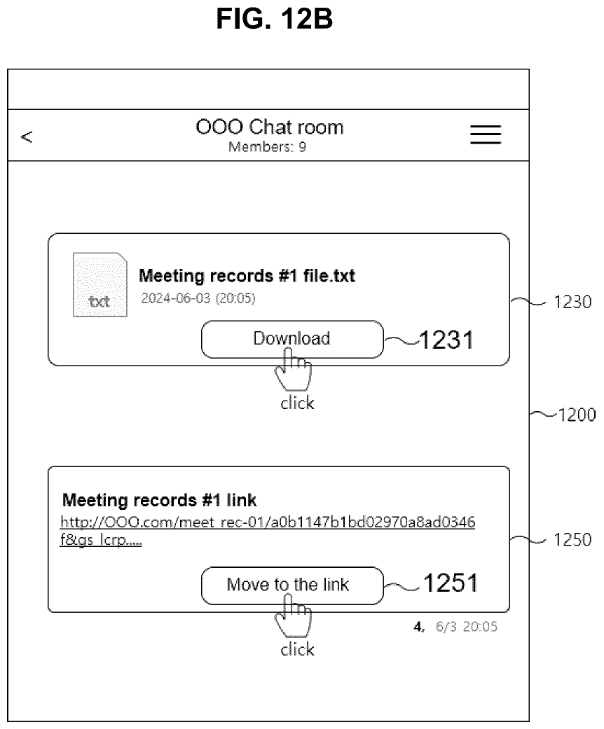

FIGS. 12A and 12B illustrate various embodiments of a process for sharing meeting records in a chat room according to the present disclosure.

Referring to FIG. 12A, the meeting records providing apparatus 130 may share the meeting records using a message display method within the chat room 1200 in which the user is participating. In other words, in the case of the message display method, the contents of the meeting records may be implemented in a way that the contents of the meeting records are inserted and displayed in the chat room 1200 as a text message 1210. The message 1210 displayed in the chat room 1200 may include the entire contents of the meeting records; if the entire contents are long, some contents may be omitted and not displayed. For example, in FIG. 12A, if the meeting records are displayed with some contents omitted, the ‘View Details’ menu 1211 may be displayed together, and the user may display the entire contents of the meeting records by selecting the menu.

Referring to FIG. 12B, the meeting records providing apparatus 130 may share the meeting records using a file attachment method or a link sharing method within the chat room 1200 in which the user is participating. In other words, in the case of the file attachment method, the meeting records file may be shared as an attachment in the chat room 1200; in the link sharing method, a link to a server (e.g., a cloud server) that may access the meeting records is shared in the chat room 1200.

For example, in FIG. 12B, the file 1230 attached within the chat room 1200 may be saved as a text file containing the entire contents of the meeting records, and users participating in the chat room 1200 may download the attached filed 1230 by selecting the ‘Download’ menu 1231 for the attached file 1230. Also, the meeting records link 1250 shared through the chat room 1200 may include an address that may directly access the meeting records; users participating in the chat room 1200 may move to a separate page where the entire contents of the shared meeting records are provided by selecting the ‘Move to the Link’ menu 1251 for the meeting records link 1250.

Although the present disclosure has been described with reference to preferred embodiments given above, it should be understood by those skilled in the art that various modifications and variations of the present disclosure may be made without departing from the technical principles and scope specified by the appended claims below.

[Detailed Description of Main Elements]

| | |
|---|---|
| 100: Meeting records providing | |
| system | |
| 110: User terminal | 130: Meeting records providing |
| | apparatus |
| 150: Database | |
| 510: Meeting records | |
| 630: Artificial intelligence model | 650, 1200: Chat room |
| 810: To-do meeting records | 830: Selection option |
| 850: Task | 870: To-do recommendation list |
| 910: First input interface | 930: Second input interface |
| 1010: General meeting records | 1030, 1110: To-do recommendation |
| | list |
| 1050: To-do meeting records | |
| 1131: First task | 1133: Second task |

1. An apparatus for providing meeting records in an artificial intelligence-based chat room, the apparatus comprising:
a memory; and
a processor electrically connected to the memory,
wherein the processor is configured to:
receive from a user terminal a user's selection for a chat room in which work participants are participating,
receive a conversation recording file that records a conversation among the work participants related to meeting contents,
generate meeting records obtained by converting the meeting contents into the text form by applying an artificial intelligence model to the conversation recording file according to the user's request for generating meeting records, and
share the meeting records through a chat room related to the user's selection.

2. The apparatus of claim 1, wherein the processor generates to-do recommendations related to the meeting contents through the artificial intelligence model when a to-do recommendation request related to the meeting records is received from the user terminal.

3. The apparatus of claim 2, wherein the processor generates a to-do recommendation list that includes the to-do recommendations and selection options for each to-do recommendation and
adds the to-do recommendation list to the meeting records or provides the to-do recommendation list through the chat room.

4. The apparatus of claim 3, wherein, if a specific work participant's selection is entered through the selection option for each to-do recommendation within the chat room, the processor generates a task related to the corresponding to-do recommendation.

5. The apparatus of claim 4, wherein, if a plurality of selection options are selected by the specific work participant, the processor sequentially generates tasks for the individual to-do recommendations.

6. The apparatus of claim 4, wherein, if the specific work participant has access rights to the meeting records, the processor activates selection options for the to-do recommendation but otherwise requests approval from a work participant having the access rights to activate the selection options for the to-do recommendation.

7. The apparatus of claim 1, wherein the processor inserts the meeting records into the chat room or a meeting map for managing meeting records depending on the location of the meeting records generation request.

8. The apparatus of claim 7, wherein the processor provides a list related to the meeting records in response to a request from any one of the work participants on the chat room or meeting map.

9. The apparatus of claim 1, wherein the processor receives a conversation among the work participants through streaming from the respective user terminals in real-time and generates the conversation recording file.

10. The apparatus of claim 1, wherein the processor inputs the conversation recording file into the artificial intelligence model to generate a script obtained by converting speeches of the work participants into text and a summary of the script and then generates the meeting records based on at least one of the script and the summary.

11. The apparatus of claim 10, wherein the processor displays the script or the summary as a conversation message of a chat room related to the user's selection.

12. The apparatus of claim 11, wherein, when a selection for the conversation message is received from any one of the work participants, the processor displays an interface related to the conversation message.

13. The apparatus of claim 12, wherein the processor provides through the interface at least one of a plurality of functions including viewing a script related to the conversation message, viewing a summary, listening to a conversation recording
the method is performed by the processor, the method comprising:
receiving from a user terminal a user's selection for a chat room in which work participants are participating;
receiving a conversation recording file that records a conversation among the work participants related to meeting contents;
generating meeting records obtained by converting the meeting contents into the text form by applying an artificial intelligence model to the conversation recording file according to the user's request for generating meeting records; and
sharing the meeting records through a chat room related to the user's selection.
